(19) United States
(12) Patent Application Publication
(10) Pub. No.: US 2006/0136642 A1
(43) Pub. Date: Jun. 22, 2006

(54) Interrupt distribution for multiprocessor system

(76) Inventor: Ping Chuin Ooi, Kangar (MY)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/020,346

(22) Filed: Dec. 21, 2004

(51) Int. Cl. G06F 13/24

(52) U.S. Cl. 710/268

(57) ABSTRACT

An interrupt distribution circuit is disclosed that receives interrupt signals and distributes the interrupt signals among a plurality of processors. The interrupt distribution circuit may enable a multi-processor system to be built using a lower cost chipset designed for systems having a single processor.

### BACKGROUND

Interrupts may transfer execution from a currently running program or task to a special procedure or task called a handler. Interrupts typically occur at random times during the execution of a program, in response to signals from hardware. Interrupts are used to handle events external to the processor, such as requests to service peripheral devices.

A processor may comprise interrupt handling mechanisms that allow interrupts to be handled transparently to application programs and the operating system. When an interrupt is received, the processor may suspend the currently running procedure or task while the processor executes an interrupt handler. When execution of the handler is complete, the processor may resume execution of the interrupted procedure or task.

In a system having two or more processors, a chipset may route an interrupt to a single processor for handling. By routing the interrupt to a single processor, the chipset ensures that only a single processor handles the interrupt which may help simplify the design of the handler.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computer system having an interrupt distribution circuit.

FIG. 2 illustrates an embodiment of the interrupt distribution circuit of FIG. 1.

FIG. 3 illustrates an embodiment of an interrupt distribution process that may be implemented by the computer system of FIG. 1.

### DETAILED DESCRIPTION

In the following detailed description, numerous specific details are described in order to provide a thorough understanding of the invention. However the present invention may be practiced without these specific details. In other stances, well known methods, procedures, components and circuits have not been described in detail so as not to obscure the present invention. Further, example sizes/models/values/ranges may be given, although the present invention is not limited to these specific examples.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following description and claims, the terms “coupled” and “connected” along with there derivatives, may be used. It should be understood that these terms are not intended as synonyms for each other. Rather in particular embodiments, “connected” may be used to indicate that two or more elements are in direct physical or electrical contacts with each other. “Coupled” may mean that two or more elements are in direct physical or electrical contact. However, “coupled” may also mean that two or more elements are not in direct contact with each other, but yet still co-operate or interact with each other.

Furthermore, elements referred to herein with a common reference label followed by a particular letter may be collectively referred to by the reference label alone. For example, processors 100a, 100b may be collectively referred to as processors 100.

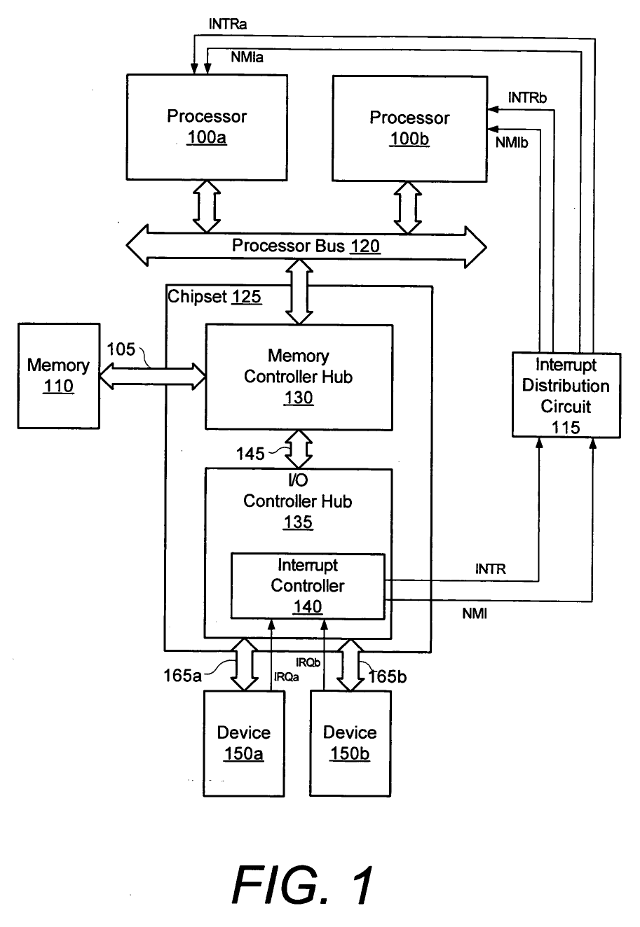

Referring to FIG. 1, an embodiment of a computer system is shown. The computer system may include processors 100a, 100b, a memory 110, an interrupt distribution circuit 115, a chipset 125, and I/O devices 150a, 150b. As depicted, a shared processor bus 120 may couple the processors 100 with the chipset 125. However, other embodiments of the computer system may comprise a separate processor bus 120 that couples each processor 100 with the chipset 125. The computer system may further comprise a memory bus 105 to couple the memory 110 to a memory controller hub 130 of the chipset 125.

Further, one or more I/O buses 165a, 165b may couple the I/O devices 150a, 150b with an I/O controller hub 135 of the chipset 125. An interrupt line INTR and a non-maskable interrupt line NMI may couple the interrupt distribution circuit 115 with an interrupt controller 140 of the I/O controller hub 135. Further, interrupt lines INTRa, INTRb and non-maskable interrupt lines NMIa, NMlb may respectively couple interrupt distribution circuit 115 with processors 100a, 100b. Finally, an interconnect bus 145 may couple the memory controller hub 130 with the I/O controller hub 140.

The processors 100 may execute software routines such as interrupt handlers that are stored in the memory 110. In one embodiment, each processor 100 may comprise a maskable interrupt pin LINT0 to receive maskable hardware interrupts and a non-maskable interrupt pin LINT1 to receive non-maskable hardware interrupts. In response to receiving an interrupt via one of its interrupt pins LINT0, LINT1, the processor 100 may execute an interrupt handler to process the received interrupt. In one embodiment, the processor 100 may comprise an IDT (Interrupt Descriptor Table) register that stores an address at which an IDT is stored in the memory 110. The IDT may comprise interrupt-gate descriptors that identify interrupt handlers or routines for associated interrupts. In one embodiment, the processor 100 may use an interrupt vector received from the interrupt controller 140 as an index into the IDT in order to obtain the appropriate interrupt-gate descriptor for the interrupt. The processor 100 may then execute an interrupt handler identified by the retrieved interrupt-gate descriptor.

The chipset 125 may comprise one or more integrated circuits or chips to couple the processors 100 with other components of the computer system. As depicted, the chipset 125 may comprise a memory controller hub 130 and a I/O controller hub 135. The memory controller hub 130 may provide an interface to memory devices of the memory 110. In particular, the memory controller hub 130 may generate signals on the memory bus 105 to read and/or write data to memory devices of the memory 110 in response to requests from the processors 100 and I/O devices 150. For example, the memory 110 may comprise RAM (Random Access Memory) devices such as source synchronous RAM devices and DDR (Double Data Rate) RAM devices and the memory controller hub 130 may generate and receive signals on bus 105 in a manner compatible with the RAM devices of the memory 110.

The I/O controller hub 135 may comprise one or more interrupt controllers 140 such as, for example, one or more Intel 8259 Programmable Interrupt Controllers (PIC). Each interrupt controller 140 may support a plurality of interrupt request lines. An interrupt controller 140 may generate a maskable interrupt signal INTR or a non-maskable interrupt signal NMI in response to one of its interrupt request lines being activated. In another embodiment, the interrupt controllers 140 may further support in-band interrupt request signals received via I/O buses 165. For example, the interrupt controllers 140 may generate a maskable interrupt signal INTR or a non-maskable interrupt signal in response to receiving an interrupt request during a PCI (Peripheral Component Interconnect) bus cycle or a PCI Express transaction.

The interrupt controller 140 may be programmable in various aspects. For example, in one embodiment, the interrupt controller 140 may programmatically assign different priority levels to its interrupt request lines and/or may programmatically assign whether an interrupt request results in a maskable interrupt or a non-maskable interrupt. Further, the interrupt controller 140 may programmatically enable and disable certain interrupts. In particular, the interrupt controller 140 may disable generation of interrupt signals for interrupt requests received via certain interrupt request lines and/or received from certain I/O devices 150. Moreover, the interrupt controller 140 may provide the processor 100 with an interrupt vector that the processor 100 may use to identify an interrupt handler for the generated interrupt.

As depicted, the computer system may comprise I/O devices 150. The I/O devices 150 may provide various input/output functions for the computer system. For example, the I/O devices 150 may comprise hard disk drives, keyboards, mice, CD (compact disc) drives, DVD (digital video discs) drives, printers, scanners, etc. Further, the I/O devices 150 may be coupled to the I/O controller 140 via various I/O buses such as, for example, PCI (Peripheral Component Interconnect) buses, PCI Express buses, USB (Universal Serial Bus) buses, SATA (Serial Advanced Technology Attachment) buses, etc.

The I/O devices 150 may generate interrupt requests to cause the interrupt controller 140 to interrupt a processor 100 in order to handle an event of the I/O device 150. To this end, interrupt request lines IRQa, IRQb may connect one or more I/O devices 150 to interrupt inputs of the interrupt controller 140. Such I/O devices 150 may activate an interrupt request line to request the interrupt controllers 140 to interrupt a processor 100 on its behalf. In other embodiments, the I/O devices 150 may send an interrupt request to the I/O controller hub 135 by generating a bus cycle, bus transaction, or some other signal on the I/O bus 165. In some embodiments, the I/O controller hub 135 may activate an interrupt input of the interrupt controller 140 in response to receive such an interrupt request via a I/O bus 165.

In one embodiment, the chipset 125, the I/O controller hub 135, and/or the interrupt controller 140 may not be designed to support more than one processor 100. In another embodiment, the chipset 125 may support more than one processor 100; however, the chipset 125, the I/O controller hub 135, and/or the interrupt controller 140 may be validated only for single processor systems. In either case, the interrupt controller 140 may not support or may not reliably support delivery of interrupts to more than one processor 100. Accordingly, in one embodiment, the computer system 125 further includes interrupt distribution circuit 115 that is external to the chipset 125 and/or the interrupt controller 140 to delivery or distribute interrupts among multiple processors 100 of a multi-processor system. In one embodiment, the interrupt distribution circuit 115 may receive maskable interrupts and non-maskable interrupts from the interrupt controller 140 of the chipset 125 and distribute the received interrupts to the processors 100. In particular, the interrupt distribution circuit 115 may ensure that each received interrupt is delivered to only one processor 100 for handling. Further, the interrupt distribution circuit 115 may distribute the interrupts to the processors 100 using various distribution schemes that spread the workload of handling interrupts among the processors 100.

Accordingly, the interrupt distribution circuit 115 may enable a system designer to use a chipset 125 that was designed and/or validated for single processor systems in a dual or multiprocessor system. In particular, the system designer may populate a motherboard with a uni-processor chipset 125 and a interrupt distribution circuit 115 to obtain a motherboard that supports two or more processors. Since there is typically a premium for chipsets that support two or more processors, a system designer may enjoy substantial cost savings by using a uni-processor chipset. As a result of these cost savings, vendors may be able to offer their consumers lower cost and/or value priced multi-processor computer systems.

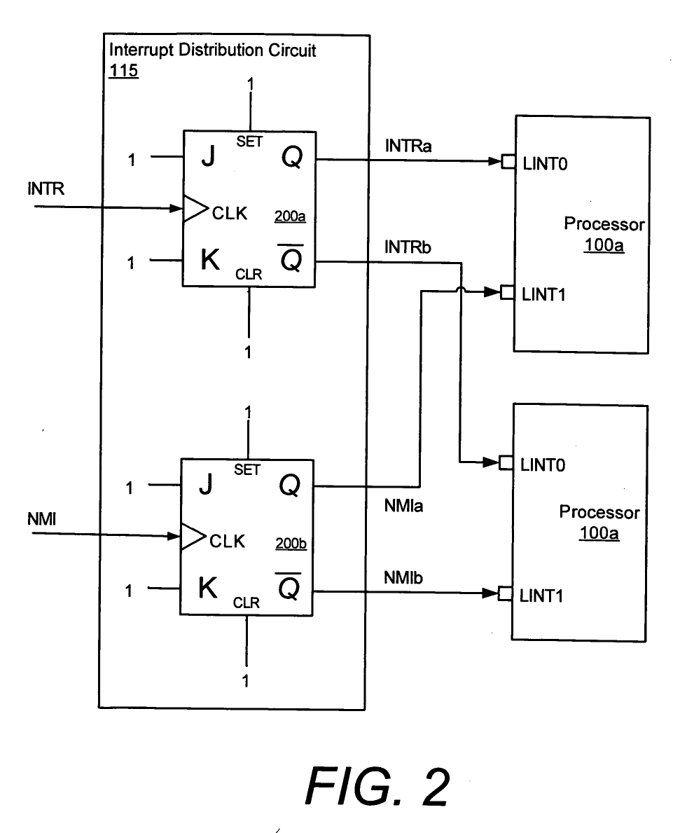

Referring now to FIG. 2, one embodiment of the interrupt distribution circuit 115 and its interconnection with the processors 100a, 100b is illustrated. The depicted interrupt distribution circuit 115 implements a round-robin distribution scheme; however, other embodiments of the interrupt distribution circuit 115 may implement other distribution schemes that distribute interrupt processing across the processors 100 of the system. As depicted, the interrupt distribution circuit 115 may comprise a flip-flop 200a to receive a maskable interrupt signal INTR from the interrupt controller 140 of the chipset 125 and a flip-flop 200b to receive a non-maskable interrupt signal NMI from the interrupt controller 140 of the chipset 125. In the embodiment depicted, the flip-flops 200 are JK flip-flops. However, other embodiments may use other types of flip-flops such as D flip-flops and T flip-flops. Moreover, other embodiments may use other types of combinatory logic in addition to and/or instead of the JK flip-flops of FIG. 2.

As depicted, the data inputs J, data inputs K, set inputs SET and clear inputs CLR of the JK flip-flops 200 are all tied to a logical “1,” value. As a result, the JK flip-flops 200 may operate in a manner similar to a T flip-flop. In particular, a JK flip-flop 200 may toggle a stored data bit between a logical “0” and a logical “1” in response to an edge of a signal received by its clock input CLK. In particular, if the stored data bit is a “1”, then the JK flip-flop 200 may toggle the stored data bit to a logical “0” in response to a rising edge of a signal received by the clock input CLK. Conversely, if the stored data bit is a “0”, then the JK flip-flop 200 may toggle the stored data bit to a logical “1” in response to a rising edge of a signal received by the clock input CLK.

Furthermore, the JK flip-flop 200 may output the state of the stored data bit on the data output Q and the opposite state of the stored data bit on the data output \overline{Q}. In other words, if the stored data bit is a logical “1”, then the data output \overline{Q} is a “1” and the data output Q is a “0”. Conversely, if the stored data bit is a logical “0”, then the data output Q is “0” and the data output \overline{Q} is a “1”. As a result, the JK flip-flop 200 may toggle the data output Q and the data output \overline{Q} between “0” and “1” as a result of toggling the stored data bit in response to an edge of the clock input CLK.

As depicted, the data output Q of the JK flip-flop 200a may be coupled to the maskable interrupt pin LINT0 of the processor 100a and the data output \overline{Q} of the JK flip-flop 200a may be coupled to the maskable interrupt pin LINT0 of the processor 100b. As a result of such an interconnection, only one of the maskable interrupt pins LINT0 of the processors 100 is activated at a given time. Thus, the interrupt distribution circuit 115 may ensure that a single processor 100 is interrupted to process a maskable interrupt. Similarly, the data output Q of the JK flip-flop 200b may be coupled to the non-maskable interrupt pin LINT1 of the processor 100a and the data output \overline{Q} of the JK flip-flop 200b may be coupled to the non-maskable interrupt pin LINT1 of the processor 100b. As a result of such an interconnection, only one of the non-maskable interrupt pins LINT1 of the processors 100 is activated at a given time. Thus, the interrupt distribution circuit 115 may ensure that a single processor 100 is interrupted to process a non-maskable interrupt. In particular, in one embodiment, the interrupt distribution circuit 115 alternately selects between two processors 100a, 100b for processing an interrupt as a result of toggling the stored data bit of the flip-flops 200.

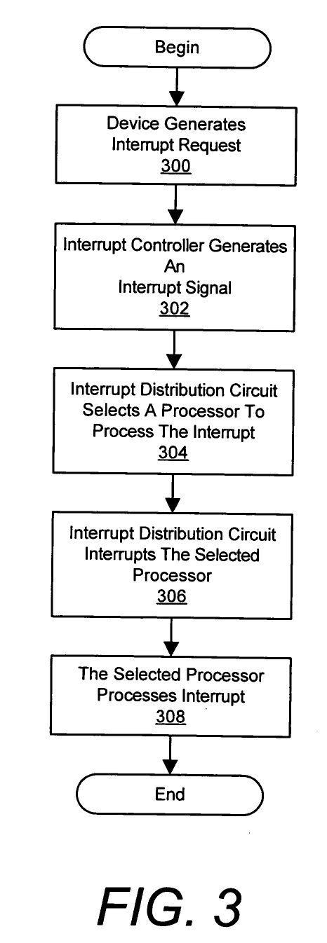

Reference is now made to FIG. 3 which depicts a process of distributing interrupts across the processors 100 of a computer system. In block 300, an I/O device 150a may provide the chipset 125 with an interrupt request. In one embodiment, the I/O device 150a may activate its interrupt request line IRQa to signal to the interrupt controller 140 of the chipset 125 that the I/O device 150a has generated an interrupt event. However, as indicated above, the I/O device 150a may provide the chipset 125 with the interrupt request via other methods such as, for example, sending an interrupt request message via the I/O bus 165a.

In response to receiving the interrupt request, the chipset 125 may generate an interrupt signal. In one embodiment, the interrupt controller 140 may determine whether to issue an interrupt signal for the received interrupt request and may determine the type of interrupt signal to issue. Assuming the interrupt controller 140 determines to generate an maskable interrupt in response to the received interrupt request, the interrupt controller 140 in block 302 generate a maskable interrupt. In particular, the interrupt controller 140 may activate the maskable interrupt line INTR to inform the interrupt distribution circuit 115 that a maskable interrupt has occurred.

In block 304, the interrupt distribution circuit 115 may select a processor 100 to process the interrupt. In one embodiment, the interrupt distribution circuit 115 may select the processor by updating the data bit stored in the flip-flop 200a in response to the clock input CLK of the flip-flop 200a receiving the activated maskable interrupt signal from the interrupt controller 140. In particular, the interrupt distribution 115 may select the processor 100a in response to the data bit being updated to a logical “1” and may select the processor 100b in response to the data bit being updated to a logical “0”.

The interrupt distribution circuit 115 in block 306 may interrupt the selected processor 100. In one embodiment, the interrupt distribution circuit 115 may interrupt the selected processor 100 by activating the maskable interrupt line of the selected processor 100 and may deactivate the maskable interrupt lines of the other processors 100. For example, if the updated data bit of the flip-flop 200a is a logical “1”, then the interrupt distribution circuit 115 may activate the maskable interrupt line INTRa and de-activate the maskable interrupt line INTRb in order to apply a maskable interrupt signal to the maskable interrupt pin LINT0 of the processor 100a.

The processor 100 receiving the maskable interrupt signal may then process the received maskable interrupt (block 308). For example, if the processor 100a received the maskable interrupt signal and the processor 100a has not masked or otherwise disabled interrupt processing, the processor 100a may request an interrupt vector from the interrupt controller 140 thereby clearing the interrupt from the interrupt controller 140. The processor 140 may use the received interrupt vector to obtain the appropriate interrupt-gate descriptor from the IDT in memory 110. The processor may then execute the interrupt handler identified by the interrupt-gate descriptor in order to process the received maskable interrupt.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. In an interrupt distribution circuit external to an interrupt controller, a method comprising
receiving an interrupt signal from the interrupt controller, and
activating a processor of a plurality of processors to process the interrupt signal.

2. The method of claim 1 wherein receiving an interrupt signal comprises receiving the interrupt signal from an interrupt controller of a chipset.

3. The method of claim 1 further comprising selecting only one processor from the plurality of processors, wherein
activating comprises activating the selected processor to process the interrupt signal.

4. The method of claim 1 further comprising alternately selecting between a first processor and a second processor of the plurality of processors, wherein
activating comprises activating the selected processor.

5. The method of claim 1 wherein activating the processor comprises activating an interrupt line of the processor.

6. A method comprising
receiving an interrupt signal from a chipset,
selecting a processor from a plurality of processors, and
interrupting the selected processor to execute an interrupt handler routine.

7. The method of claim 6 wherein receiving an interrupt signal comprises receiving the interrupt signal from an interrupt controller of the chipset.

8. The method of claim 6 wherein selecting a processor comprises alternately selecting between a first processor and a second processor of the plurality of processors.

9. The method of claim 6 wherein interrupting the selected processor comprises activating an interrupt line of the selected processor.

10. A system comprising
a plurality of processors to process interrupt signals,
an interrupt controller to issue interrupt signals, and
an interrupt distribution circuit external to the interrupt controller to distribute interrupt signals among the plurality of processors.

11. The system of claim 10 further comprising input-output controller hub to control input-output devices and to receive interrupt requests from the input-output devices, wherein the interrupt controller is part of the input-output controller hub.

12. The system of claim 10 further comprising
memory to store data, and
a chipset to read data from the memory, to write data to the memory, to control input-output devices, and to receive interrupt requests from the input-output devices, wherein
the interrupt controller is part of the chipset, and
the interrupt distribution circuit is external to the chipset.

13. The system of claim 12 wherein the chipset supports only a single processor.

14. The system of claim 12 wherein the chipset is validated for only a single processor.

15. A system comprising
a plurality of processors,
an input-output controller hub to receive interrupt requests from an input-output device and to generate interrupt signals in response to receiving interrupt requests, and
an interrupt distribution circuit external to the input-output controller hub,
the interrupt distribution circuit to distribute processing of the interrupt signals among the plurality of processor.

16. The system of claim 15 wherein the interrupt distribution circuit
alternately selects between a first processor and a second processor of the plurality of processors in response to an interrupt signal, and
interrupts the selected processor to process the interrupt signal.

17. The system of claim 15 further comprising
memory to store data, and
a memory controller hub to read data from the memory and to write data to the memory in response to requests received from the plurality of processors, wherein
input-output controller hub supports delivery of interrupt signals to only a single processor.

18. The system of claim 15 further comprising
memory to store data, and
a memory controller hub to read data from the memory and to write data to the memory in response to requests received from the plurality of processors,
wherein
input-output controller hub is only validated to deliver interrupt signals to a single processor.

19. An interrupt distribution circuit comprising a circuitry
to alternately select between a first processor and a second processors of a plurality of processors in response to an interrupt signal received from an interrupt controller, and
to interrupt the selected processor to process the interrupt signal.

20. The interrupt distribution circuit of claim 19 wherein the circuitry comprises a flip-flop having a stored bit that toggles between a logical “0” and a logical “1” in response to the interrupt signal.

21. The interrupt distribution circuit of claim 20 wherein the circuitry interrupts the first processor in response to the stored bit being updated to the logical “1” and interrupts the second processor in response to the stored bit being updated to the logical “0”.
